(19) United States
(12) Patent Application Publication
(10) Pub. No.: US 2009/0138860 A1
(43) Pub. Date: May 28, 2009

(54) PROGRAM ANALYSIS METHOD AMD APPARATUS

(75) Inventors: Yujiro FUSEGAWA, Kawasaki (JP); Tamaki Makita, Kawasaki (JP); Shigeo Suto, Sendai (JP); Hiroyuki Kamata, Sendai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/358,893

(22) Filed: Jan. 23, 2009

Related U.S. Application Data
(63) Continuation of application No. PCT/JP2006/316008, filed on Aug. 14, 2006.

(51) Int. Cl. G06F 9/44

(52) U.S. Cl. 717/131

(57) ABSTRACT

A program analysis method includes: analyzing, for each program, correlation between plural property values of properties including a property concerning a cost and the accumulated number of failures; calculating a failure forecast value for each program, based on the analysis result and the plural property values of the properties including the property concerning the cost; calculating a latent risk value for each program based on the accumulated number of failures, the failure forecast value, an assumed damage degree per one failure; and selecting a program to be processed based on the latent risk values. Thus, it becomes possible to identify a program for which the maintenance should be carried out, based on the latent risk.

### CROSS-REFERENCE TO RELATED APPLICATIONS

This application is a continuing application, filed under 35 U.S.C. section 111 (a), of International Application PCT/JP2006/316008, filed Aug. 14, 2006.

### FIELD

This invention relates to an analysis technique of a program, more particularly to a program analysis technique for maintenance of the program.

### BACKGROUND

In conventional arts, the scale based on the number of steps is used as a gauge of the quality, cost and development term in the development and maintenance of the software. Although the scale estimation based on the number of steps is appropriate to some degree in the new development, it was difficult to evaluate and estimate the quality, cost and maintenance term in the maintenance stage only by the number of steps to be modified. This is because the influence to the modification target and/or the complexity of the modification target are not quantitatively measured and they are not always reflected to the number of steps to be modified. And, a function point method to measure the quantity of the functions as the gauge of the scale in the cost estimation has been used. However, it is also difficult for this method to carry out the cost estimation for the maintenance and this method is also unappropriate for the quality evaluation. Moreover, although some other software metricses are contrived, the main object of such metricses is the quality evaluation, and there is no universal metrics because they have respective project characteristics. Accordingly, in the present state, the evaluation of the cost and/or the development term is carried out only by the scale (e.g. the number of steps, function points or the like).

For example, Japanese Laid-open Patent Publication No. 07-160495 disclosesagoodsourcecodeevaluationapparatusenablingthequalityevaluation of the software easily and quickly, and enabling to transfer information concerning the quality at high speed and quickly deal with quality problems. Specifically, an information collection unit collects source codes to configure a system to be evaluated from each terminal. A quality metrics value measurement unit measures a quality metrics value of the source codes. Based on the measured quality metrics value, a system quality evaluation unit carries out the quality evaluation for the system to be evaluated. Based on the system evaluation result, a danger program extraction unit extracts a dangerous program having high possibility of the occurrence of troubles. An information feedback unit feeds back the evaluation result and a danger degree of the program to each terminal. However, the cost is not considered, and because the maintenance state until the evaluation is not reflected, it is impossible to set the priority in the maintenance and evaluate the cost-effectiveness.

### SUMMARY

Thus, in the conventional arts, it is impossible to set the priority in the maintenance and evaluate the cost-effectiveness and the like while considering the application characteristics, which does not appear in view of the scale, in order to realize high-quality programs by an appropriate cost in the maintenance.

Hence, an object of this invention is to provide a new program analysis technique for the program maintenance.

In addition, another object of this invention is to provide a technique enabling to set the priority of the program maintenance, rationally.

Furthermore, still another object of this invention is to provide a technique enabling the program maintenance according to the cost-effectiveness.

A program analysis method according to a first aspect of this invention includes: analyzing, for each program, correlation between a plurality of property values of properties including a property concerning a cost, which are stored in a property data storage device, and the accumulated number of failures, which is stored in a quality result data storage device, and storing an analysis result into a storage device; calculating a failure forecast value for each program, based on the analysis result stored in the storage device and the plurality of property values of the properties including the property concerning the cost, which are stored in the property data storage device, and storing the calculated failure forecast value into a program job damage data storage device; calculating a latent risk value for each program, based on the accumulated number of failures, which is stored in the quality result data storage device, the failure forecast value stored in the program job damage data storage device and an assumed damage degree per one failure, and storing the latent risk value into the program job damage data storage device; and selecting a program to be processed based on the latent risk values stored in the program job damage data storage device.

Thus, it becomes possible to identify a program for which the maintenance should be carried out, based on the latent risk. Incidentally, the latent risk is calculated also taking into consideration the accumulated number of failures, which represents the present maintenance state, and represents a risk other than problems, which have appeared. Accordingly, it can represent the necessity and/or the priority of the maintenance, appropriately.

Moreover, the program analysis method may further include: analyzing, for each program, correlation between a plurality of property values of properties exclusive of the property concerning the cost, which are stored in the property data storage device, and the accumulated number of failures, which is stored in the quality result data storage device, and storing the analysis result as a second analysis result into the storage device; calculating a second failure forecast value for each program based on the second analysis result stored in the storage device and the plurality of property values of the properties exclusive of the property concerning the cost, and storing the second failure forecast value into the program job damage data storage device; calculating, for each program, a cost influence ratio based on the failure forecast value and the second failure forecast value, which are stored in the program job damage data storage device, and storing the cost influence ratio into the storage device; calculating a unit cost that represents a cost per a functional scale, which is necessary to make the number of failures zero based on data of the cost influence ratio for each program, which is stored in the storage device, and a property value concerning the cost per the functional scale for each program, which is stored in the property data storage device, and storing the unit cost into the storage device; and calculating a cost necessary to ensure a predetermined level of quality for at least the identified program to be processed, by using the unit cost stored in the storage device, the property value concerning the cost per the functional scale for each program, which is stored in the property data storage device, the failure forecast value for each program, which is stored in the program job damage data storage device, and the accumulated number of failures stored in the quality result data storage or the number of latent failures, which is a difference between the failure forecast value and the accumulated number of failures, and storing the calculated cost into the program job damage data storage device.

Thus, the cost necessary to ensure the predetermined level of quality is calculated. Accordingly, it becomes possible to carry out the maintenance in such a manner that the cost-effectiveness is took into account.

Furthermore, the program analysis method may further include: calculating an assumed damage degree per one damage, based on a damage cost corresponding to a job damage rank of a program and a cost of the program, which corresponds to a specific property included in the plurality of properties, and storing the assumed damage degree into the program job damage data storage device. Thus, by reflecting the job damage rank of the program, namely, the influence to the job, it becomes possible to calculate the latent risk much in association with the job.

In addition, the aforementioned calculating the latent risk value may include: calculating, for each program, the number of latent failures based on the accumulated number of failures, which is stored in the quality result data storage device, and the failure forecast value stored in the program job damage data storage device, and storing the number of latent failures into the program job damage data storage device; and calculating, for each program, the latent risk value based on the number of latent failures and the assumed damage degree per one failure, which are stored in the program job damage data storage device, and storing the latent risk value into the program job damage data storage device. For example, when the difference between the number of latent failures and the accumulated number of failures is negative, “0” may be set to the number of latent failures. In addition, in such a case, the failure forecast value may be calculated again by exchanging the property of the program.

Furthermore, the aforementioned selecting may include: sorting the programs based on values of the latent risks, which are stored in the program job damage data storage device; and accumulating the values of the latent risks in an ascending order of the value of the latent risk, and selecting, as the programs to be processed, a specific program at which the accumulated value of the latent risk value exceeds a predetermined threshold and programs whose value of the latent risk is greater than that of the specific program. Thus, it becomes possible to identify, as the programs to be maintained, the programs whose latent risks exceed the permissible risk as a whole.

Furthermore, the aforementioned calculating the unit cost may include: analyzing correlation between data of the cost influence ratio for each program, which is stored in the storage device, and the property value concerning the cost per the functional scale for each program, which is stored in the property data storage device, and storing the result of the analysis, as a third analysis result, into the storage device; and calculating, as the unit cost, a cost per the functional scale at which the cost influence ratio becomes zero, according to the third analysis result stored in the storage device, and storing the unit cost into the storage device. Thus, it becomes possible to identify the suitable cost (i.e. the cost per functional scale, which is necessary to reduce the failure to zero).

In addition, the aforementioned calculating the cost may include: calculating, for each program, an ideal cost based on the unit cost stored in the storage device and the property value concerning the cost per the functional scale for each program, which is stored in the property data storage device, and storing the ideal cost into the program job damage data storage; calculating a failure rate (hereinafter, also called a latent failure ratio) for the failure forecast ratio for at least the program to be processed, by using the failure forecast value for each program, which is stored in the program job damage data storage device, and the accumulated number of failures which is stored in the quality result data storage, or the number of latent failures, which represents the difference between the failure forecast value and the accumulated number of failures, and storing the failure rate into the storage device or the program job damage data storage device; and calculating the cost necessary to ensure the predetermined level of quality for at least the program to be processed, based on the ideal cost for each program, which is stored in the program job damage data storage, and the latent failure ratio stored in the storage device or the program job damage data storage device, and storing the calculated cost into the program job damage data storage device.

A program analysis method according to a second aspect of this invention includes: analyzing, for each program, correlation between a plurality of property values of properties including a property concerning a cost, which are stored in a property data storage device, and the accumulated number of failures, which is stored in a quality result data storage device, and storing the analysis result into a storage device; calculating, for each program, a first failure forecast value, based on the analysis result stored in the storage device and the plurality of property values of the properties including the property concerning the cost, which are stored in the property data storage device, and storing the first failure forecast value into the program job damage data storage device; analyzing, for each program, correlation between a plurality of property values of properties exclusive of the property concerning the cost, which are stored in the property data storage device, and the accumulated number of failures, which is stored in the quality result data storage device, and storing the analysis result as a second analysis result, into the storage device; calculating, for each program, a second failure forecast value, based on the second analysis result stored in the storage device and the plurality of property values of the properties exclusive of the property concerning the cost, which are stored in the property data storage device; calculating, for each program, a cost influence ratio based on the first failure forecast value and the second failure forecast value, which are stored in the program job damage data storage device, and storing the cost influence ratio into the storage device; calculating a unit cost, which represents a cost per a functional scale, which is necessary to make the failure zero, based on data of the cost influence ratio for each program, which is stored in the storage device, and a property value concerning the cost per the functional scale for each program, which is stored in the property data storage device, and storing the unit cost into the storage device; and calculating a cost necessary to ensure a predetermined level of quality for at least a part of programs, by using the unit cost stored in the storage device, the property value concerning the cost per the functional scale for each program, which is stored in the property data storage device, the first failure forecast value for each program, which is stored in the program job damage data storage device, and the accumulated number of failures, which is stored in the program job damage data storage device, or the number of latent failures, which is a difference between the first failure forecast value and the accumulated number of failures, and storing the calculated cost into the program job damage data storage device. Thus, because the cost necessary to ensure the predetermined level of quality is calculated, it becomes possible to carry out the maintenance in such a manner that the cost-effectiveness is taken into consideration.

It is possible to create a program causing a computer to execute the aforementioned program analysis method, and this program is stored into a storage medium or storage device such as a flexible disk, CD-ROM, magneto-optic disk, semiconductor memory, hard disk or the like. Incidentally, the intermediate processing result is temporarily stored into a storage device such as a memory.

### BRIEF DESCRIPTION OF DRAWINGS

FIG. 1 is a system outline diagram relating to an embodiment of this invention;

FIG. 2 is a functional block diagram of a program analysis apparatus;

FIG. 3 is a diagram depicting a main processing flow relating to this embodiment of this invention;

FIG. 4 is a diagram depicting a processing flow of an analysis data collection processing;

FIG. 5 is a diagram depicting an example of data stored in a resource property table;

FIG. 6 is a diagram depicting an example of data stored in a quality result table;

FIG. 7 is a diagram depicting an example of data stored in a maintenance result table;

FIG. 8 is a diagram depicting an example of data stored in a resource property table;

FIG. 9 is a diagram depicting a processing flow of a maintenance level setting processing;

FIG. 10 is a diagram depicting an example of data stored in a job damage rank conversion table;

FIG. 11 is a diagram depicting an example of data stored in a resource property value cost conversion table;

FIG. 12 is a diagram depicting an example of data stored in a program job damage degree table;

FIG. 13 is a diagram depicting an example of data stored in a program job damage degree work table;

FIG. 14 is a diagram depicting an example of data stored in the program job damage degree table;

FIG. 15 is a diagram depicting an example of a level setting table;

FIG. 16 is a diagram depicting a processing flow of an influence property identifying processing;

FIG. 17 is a diagram depicting an example of data stored in a failure forecast regression analysis table;

FIG. 18 is a diagram depicting an example of data stored in the program job damage degree table;

FIG. 19 is a diagram depicting an example of data stored in the program job damage degree table;

FIG. 20 is a diagram depicting data depicted in FIGS. 6 and 19 in a bar chart format;

FIG. 21 is a diagram depicting data depicted in FIGS. 6 and 19 in another format;

FIG. 22 is a diagram depicting an example of data stored in the program job damage degree table;

FIG. 23 is a diagram depicting a processing flow of an application resource evaluation processing;

FIG. 24 is a diagram depicting a processing flow of a target program identifying processing;

FIG. 25 is a diagram depicting an example of data stored in the program job damage degree table;

FIG. 26 is a diagram depicting a graph to discriminate the target program from the programs in the permissible range;

FIG. 27 is a diagram depicting an example of data stored in the program job damage degree table;

FIG. 28 is a diagram depicting a processing flow of a cost influence ratio determination processing;

FIG. 29 is a diagram depicting an example of data stored in the failure forecast regression analysis table;

FIG. 30 is a diagram depicting an example of data stored in the program job damage degree table;

FIG. 31 is a diagram depicting a graph representing a relation between a cost per functional scale and a cost influence ratio;

FIG. 32 is a diagram depicting an example of data stored in a cost influence ratio data table;

FIG. 33 is a diagram depicting a processing flow of a quality ensuring cost determination processing; and

FIG. 34 is a diagram depicting a functional blocks of a computer.

### DESCRIPTION OF EMBODIMENTS

FIG. 1 depicts a system outline diagram relating to an embodiment of this invention. For example, plural user terminals (e.g. a user terminal A, and a user terminal B) and a program analysis apparatus 3 that carries out a main processing in this embodiment are connected with a network 1 such as a Local Area Network (LAN). Incidentally, an embodiment in a client-server system is depicted in the following. However, a stand-alone system may be adopted.

A configuration of the program analysis apparatus 3 will be explained by using FIG. 2. The program analysis apparatus 3 includes: an input and output unit 31 that is an interface to the user terminals and the like; a maintenance result data storage 32 that stores maintenance result data, quality result data and the like, which are obtained through the input and output unit 31; an application resource storage 33 that stores source codes and the like, which are obtained, for example, through the input and output unit 31; an analysis data collection unit 34 that carries out a processing by using data and the like stored in the maintenance result data storage 32 and the application resource storage 33; an analysis data DB 37 that stores processing results of the analysis data collection unit 34; a maintenance level setting unit 35 that accepts data inputted through the input and output unit 31 from the user terminal and further carries out a processing by using data and the like, which is stored in the analysis data DB 37; a maintenance level DB 36 that stores processing results of the maintenance level setting unit 35; a quality influence property identifying unit 38 that carries out a processing by using data and the like, which is stored in the analysis data DB 37 and maintenance level DB 36; an influence property DB 39 that stores processing result of the quality influence property identifying unit 38; an application resource evaluation unit 40 that carries out a processing by using data and the like, which is stored in the maintenance level DB 36, influence property DB 39 and analysis data DB 37: and an evaluation result DB 41 that stores processing results of the application resource evaluation unit 40. Data stored in the evaluation DB 41 is outputted through the input and output unit 31 to the user terminal. Furthermore, data stored in any DB may be outputted to the user terminal.

The analysis data collection unit 34 includes a maintenance data collection unit 341 and an application property data collection unit 342. In addition, the maintenance data collection unit 341 includes a quality result data collection unit 3411 and a maintenance result data collection unit 3412.

Furthermore, the maintenance level setting unit 35 includes a damage degree setting unit 351 and a maintenance quality level setting unit 352. Moreover, the application resource evaluation unit 40 has a quality risk judgment unit 401 and a quality keeping cost judgment unit 402.

Next, processing contents of the system depicted in FIGS. 1 and 2 will be explained by using FIGS. 3 to 33. First, the input and output unit 31 and analysis data collection unit 34 carry out an analysis data collection processing (step S1). The details of this processing will be explained by using FIGS. 4 to 8. In addition, the processing results are stored into the analysis data DB 37. Next, the input and output unit 31 and the maintenance level setting unit 35 carry out a maintenance level setting processing by using data and the like, which is stored in the analysis data DB 37 (step S3). The details of this processing will be explained by using FIGS. 9 to 15. Moreover, the processing results are stored into the maintenance level DB 36.

Then, the quality influence property identifying unit 38 carries out an influence property identifying processing by using data stored in the analysis data DB 37 and maintenance level DB 36 (step S5). The details of this processing will be explained by using FIGS. 16 to 22. In addition, the processing results are stored into the influence property DB 39. Furthermore, the application resource evaluation unit 40 carries out an application resource evaluation processing by using data and the like, which is stored in the analysis data DB 37, influence property DB 39 and maintenance level DB 36 (step S7). The details of this processing will be explained by using FIGS. 23 to 33. In addition, the processing result is stored into the evaluation result DB 41. The data stored in the evaluation result DB 41 is outputted through the input and output unit 31 to the user terminal, which is a processing requesting source.

Next, the analysis data collection processing (step S3) will be explained by using FIGS. 4 to 8. The application property data collection unit 342 carries out a predetermined resource property analysis processing for all source programs, which are inputted, for example, through the input and output unit 31 and stored in the application resource storage 33, and stores the analysis result into a resource property table in the analysis data DB 37 (step S11). By using a method of a conventional art, the number of logic lines (property 1), a McCabe complexity degree (property 2), a structurized degree (e.g. the number of structurizing obstructive instructions) (property 3), update frequency (property 4), the number of associated programs (property 5), a functional scale (e.g. the functional scale=“1” in case of the number of logic lines=“100”) (property 6) are used for the analysis.

The resource property table is a table as depicted in FIG. 5, for example. That is, the table includes a column of a program name (or ID), and columns of property values of respective property. Incidentally, the property 7 is not obtained at the step S11, but is a cost per the functional scale in this case.

In addition, when the input and output unit 31 obtains quality result data of each program from, for example, the user terminal, the input and output unit 31 stores the quality result data into the maintenance result data storage 32, and the quality result data collection unit 3411 in the maintenance data collection unit 341 reads out the quality result data from the maintenance result data storage 32, and stores the quality result data into the quality result table in the analysis data DB 37 (step S13).

The quality result table is a table as depicted in FIG. 6, for example. That is, the accumulated number of failures is registered for each program name (or ID). Incidentally, the input and output unit 31 may collect the accumulated number of failures from other failure databases and the like, and store the collected data into the maintenance result data storage 32. Moreover, the quality result data collection unit 3411 may collect the accumulated number of failures.

Furthermore, when the input and output unit 31 obtains the maintenance result data for each program from, for example, the user terminal, the input and output unit 31 stores the obtained data into the maintenance result data storage 32, and the maintenance result data collection unit 3412 in the maintenance data collection unit 341 reads out the maintenance result data from the maintenance result data storage 32, and stores the maintenance result data into the maintenance result table in the analysis data DB 37 (step S15).

The maintenance result table is a table as depicted in FIG. 7, for example. That is, maintenance man-hours (its unit is man-hour, for example) corresponding to the maintenance cost is registered for each program name (or ID). Incidentally, the input and output unit 31 may collect data of the caused maintenance man-hours from other maintenance database or the like, and store the collected data into the maintenance result data storage 32. In addition, the maintenance result data collection unit 3412 may collect.

Then, the maintenance result data collection unit 3412 reads out data of the functional scale (property 6) in the resource property table in the analysis data DB 37, calculates, for each program, the cost (property 7) per the functional scale by calculating (the maintenance man-hours/the functional scale), and stores data of the property 7 into the resource property table (step S17). By carrying out such a processing, the resource property table as depicted in FIG. 8 is stored in the analysis data DB 37.

Therefore, a pre-processing at the first stage is completed, and the processing returns to the original processing.

Next, the maintenance level setting processing (step S3) will be explained by using FIGS. 9 to 15. First, the damage degree setting unit 351 in the maintenance level setting unit 35 accepts a damage cost for each job damage rank from the user terminal through the input and output unit 31, and stores the inputted damage cost into a job damage rank conversion table in the maintenance level DB 36 (step S21).

The job damage rank conversion table is a table as depicted in FIG. 10, for example. Namely, for example, the job recovery cost (man-hours) is stored in association with each of the job damage ranks A to E. The number of ranks is not limited to 5 stages of A to E.

In addition, the damage degree setting unit 351 accepts an input of an investigation and correction cost for each specific property value in the resource property table in the analysis data DB 37 from the user terminal through the input and output unit 31, and stores the investigation and correction cost into a resource property value cost conversion table in the maintenance level DB 36 (step S23).

The resource property value cost conversion table is a table as depicted in FIG. 11, for example. Namely, the table includes a column of a property type name, a column of a property value, and a column of a cost (man-hours), which represents difficulty of the investigation and correction for the failure. In the example of FIG. 11, as for the property 5, namely, the number of associated programs, the cost is registered in association with each property value. However, data of another property or plural properties may be registered.

Then, the damage degree setting unit 351 accepts an input of a job damage rank for each program in the resource property table in the analysis data DB 37 from the user terminal through the input and output unit 31, and stores the job damage rank into the program job damage degree table (stop S25).

The program job damage degree table is a table as depicted in FIG. 12, for example. That is, the job damage rank, a damage degree per one failure and the like are registered for each program name (or ID). However, at the step S25, only the job damage rank is registered.

Furthermore, the damage degree setting unit 351 copies the program job damage degree table to generate a program job damage degree work table, and searches the job damage rank conversion table in the maintenance level DB 36 by the job damage rank of each program to identify the damage cost, and stores the identified damage cost into the program job damage degree work table (step S27).

The program job damage degree work table is a table as depicted in FIG. 13, for example. Namely, the job damage rank, the damage cost, the number of associated programs (i.e. property 5), the cost based on the resource property value cost conversion table and the damage degree per one failure are registered for each program name (or ID). Incidentally, at the step S27, the job damage rank (e.g. “A”) copied from the program job damage degree table and the damage cost (e.g. “10” corresponding to “A”) based on the job damage rank conversion table are registered.

Moreover, the damage degree setting unit 351 identifies the investigation and correction cost corresponding to the resource property value (property value of the property 5) of each program, by using the resource property value cost conversion table in the maintenance level DB 36 and the resource property table in the analysis data DB 37, and stores the investigation and correction cost into the program job damage degree work table (step S29).

As depicted in FIG. 13, the value (e.g. “3”) of the property 5 and the investigation and correction cost (e.g. “5” corresponding to “3”) in the resource property value cost conversion table are registered into the program job damage degree work table.

Then, the damage degree setting unit 351 calculates the damage degree per one failure by adding the damage cost of each program and the investigation and correction cost and stores the damage degree into the program job damage degree table (step S31).

For example, in case of the program A, the damage cost is “10”, and the investigation and correction cost is “5”. Accordingly, the damage degree per one failure is calculated as “15”. By carrying out such a processing, the program job damage degree table as depicted in FIG. 14 is generated.

Furthermore, the maintenance quality level setting unit 352 of the maintenance level setting unit 35 accepts an input of the damage tolerance from the user terminal through the input and output unit 31, and stores the damage tolerance into the level setting table of the maintenance level DB 36 (step S33). The level setting table is a table storing only the damage tolerance as depicted in FIG. 15.

Accordingly, the second pre-processing is completed and the processing returns to the original processing.

Next, the influence property identifying processing (step S5) will be explained by using FIGS. 16 to 22. The quality influence property identifying unit 38 analyzes the correlation between the property values of the resource properties for each program, which are stored in the resource property table in the analysis data DB 37, and the accumulated number of failures, which is stored in the quality result table, by the multiple regression analysis, and stores the calculated partial regression coefficients into the failure forecast regression analysis table in the influence property DB 39 (step S41). Because the multiple regression analysis is well-known, the detail explanation is omitted. However, at the step S41, the cut is assumed to be zero. In addition, at the step S41, the property 7 is always an analysis target, and other properties may not be the analysis targets. Incidentally, the analysis of the correlation is not limited to the multiple regression analysis.

The failure forecast regression analysis table is a table as depicted in FIG. 17, for example. Namely, the table includes a column of a regression analysis type, a column of the cut, a column of a coefficient of the property 1, a column of a coefficient of the property 2, a column of a coefficient of the property 3, a column of a coefficient of the property 4, . . . and a column of a coefficient of the property 7. Because the property 7 is the cost per the functional scale and the accumulated number of failures decreases when increasing the cost, the sign of the coefficient of the property 7 is negative. The signs of the other coefficients are positive, normally.

Then, the quality influence property identifying unit 38 calculates a first failure forecast value of each program from the property values of the resource properties for each program and the partial regression coefficients of the resource properties, and stores the first failure forecast value into the program job damage degree table in the maintenance level DB 36 (step S43). The first failure forecast value is a value calculated by adding all of (the partial regression coefficient of the property i×the property value of the property i) for each property 1 to n (n is the maximum value of the property number. However, the properties are limited to the analysis targets.). The program job damage degree table becomes a state as depicted in FIG. 18, for example.

Furthermore, the quality influence property identifying unit 38 calculates, as the number of latent failures, a difference between the first failure forecast value of each program and the accumulated number of failures, which is stored in the quality result table in the analysis data DB 37, and stores the number of latent failures into the program job damage degree table in the maintenance DB 36 (step S45). However, in this embodiment, when the value of (the first failure forecast value—the accumulated number of failures) is negative, “0” is set to the number of latent failures. When the processing is carried out by this step, the program job damage degree table becomes a state as depicted in FIG. 19. For example, PGM 1 has possibility that about 8 failures occur more when taking into account the present maintenance state.

When summarizing data stored in the quality result table and the program job damage degree table at this stage, data depicted in FIG. 20 is obtained, for example. In the graph in FIG. 20, a vertical axis represents the number of failures, and a horizontal axis represents respective programs. In addition, a white bar represents the accumulated number of failures, and a bar with hatching represents the first failure forecast value. Moreover, data as depicted in FIG. 21 may be obtained. In the graph of FIG. 21, the vertical axis represents the accumulated number of failures, and the horizontal axis represents the first failure forecast value. Moreover, a line A represents the 45-degree line.

The programs (PGM 1, PGM 2, PGM 3 and PGM 4) whose left bar is lower than the right bar in FIG. 20 and programs, which are plotted in an area under the line A in FIG. 21, are programs having a risk that the failure occurs latently, because the first failure forecast value is greater than the accumulated number of failures. On the other hand, the programs (PGM 5, PGM 6 and PGM 7) whose left bar is higher than the right bar in FIG. 20 and programs, which are plotted in an area higher than the line A in FIG. 21 are programs having possibility that other properties exist that become failure causing factors (also called deterioration factor property), because the first failure forecast value is less than the accumulated number of failures. In such a case, there is a case where the property for which the regression analysis is carried out is changed or added. Then, the program (PGM 8) whose height of the right bar is almost the same as that of the left bar or program, which is plotted on the line A in FIG. 21, is a program that all of the failures have been fixed, there is no risk that any failure occurs latently and there is no other property that becomes the failure causing factor.

Such analysis results may be transmitted to the user terminal to present them for the user.

Then, the quality influence property identifying unit 38 calculates a damage risk from a product of the number of latent failures for each program and the damage degree per one failure, which are stored in the program job damage degree table, and stores the calculated damage risk into the program job damage degree table in the maintenance level DB 36 (step S47).

When the processing is carried out by this stage, the program job damage degree table stores data as depicted in FIG. 22. Thus, the present damage risk can be identified for each program, by using the damage degree per one failure, for which the importance degree (i.e. job damage rank) of the program on the business is taken into account, and the number of latent failures for which the maintenance state is taken into account.

Thus, the processing returns to the original processing.

Next, the application resource evaluation processing (step S7) will be explained by using FIGS. 23 to 33. This application resource evaluation processing includes a target program identifying processing (FIG. 23: step S51) executed by the quality risk judgment unit 401, a cost influence ratio determination processing (FIG. 23: step S53) and quality ensuring cost determination processing (FIG. 23: step S55) executed by the quality keeping cost judgment unit 402.

First, the target program identifying processing (step S51) will be explained by using FIGS. 24 to 27. First, the quality risk judgment unit 401 sorts the programs (i.e. records) in the program job damage degree table in a descending order of the value of the damage risk, for example (step S61). Then, the program job damage degree table becomes a state depicted in FIG. 25. In the descending order of the damage risk, PGM 1, PGM 2, PGM 4 and PGM 3 are arranged.

Then, the quality risk judgment unit 401 initializes an accumulated risk r=0 (step S63), and identifies the damage risk r1 of the lowest-ranked program (step S65). For example, the lowest-ranked program may be limited to the lowest-ranked among the programs having the damage risk program that exceeds “0”. Then, the quality risk judgment unit 401 calculates the accumulated risk r=r+r1 (step S67). Then, the quality risk judgment unit 401 judges whether or not the accumulated risk r is greater than the damage tolerance stored in the level setting table in the maintenance level DB 36 (step S69). When the accumulated risk r is equal to or less than the damage tolerance (step S69: No route), the quality risk judgment unit 401 identifies the damage risk r1 of the next-higher-ranked program (step S71), and the processing returns to the step S67. On the other hand, when the accumulated risk r is greater than the damage tolerance (step S69: Yes route), the quality risk judgment unit 401 sets in the program job damage degree table, ON, to a target flag of the program identified at a step which was carried out lastly among the step S65 and S71, and programs whose rank is higher than the rank of the identified program (step S73). The program job damage degree table that is a processing result of this step is stored into the evaluation result DB 41.

In the example of FIG. 25, the damage tolerance is “20”, and because the damage risk of only PGM 3 is “13”, the accumulated risk r is within a permissible range. However, the accumulated risk r of PGM 3 and PGM 4 becomes “29”, and exceeds the permissible range. Therefore, as depicted in FIGS. 26 and 27, ON is set to the target flags for PGM 4 and PGM 2 and PGM 1, which are ranked higher than PGM 4, and OFF is kept for the target flags of PGM 3 and programs, which are ranked lower than PGM 3, because they are within the permissible range.

By carrying out the aforementioned processing, it is possible to identify programs having the latent risk, which exceeds the damage tolerance, and it is also possible to narrow the maintenance target according to the latent risk.

Next, the cost influence ratio determination processing (step S53) will be explained by using FIGS. 28 to 32. First, the quality keeping cost judgment unit 402 analyzes the correlation between the accumulated number of failures for each program, which is stored in the quality result table in the analysis data DB 37, and property values of the resource properties (exclusive of the property concerning the cost), which are stored in the resource property table, by the multiple regression analysis, and stores the calculated partial regression coefficients into the failure forecast regression analysis table (step S81). The multiple regression analysis is well-known. Therefore, the further explanation is omitted. The property 7 in the example of the resource property table as depicted in FIG. 8 represents the cost per the functional scale. Accordingly, this property is excluded from the properties to be analyzed. Incidentally, the analysis of the correlation is not limited to the multiple regression analysis.

Moreover, the failure forecast analysis table becomes a table as depicted in FIG. 29 when the step S81 is executed. That is, when the step S81 is executed, any coefficient is not calculated for the property 7, and a second record (whose regression analysis type is “2”) in which the partial regression coefficient for the properties to be analyzed other than the property 7 are generated and registered.

Next, the quality keeping cost judgment unit 402 calculates a second failure forecast value for each program, based on the property values of the resource properties for each program, which are stored in the resource property table and the partial regression coefficients of the property values of the resource properties, which are stored in the failure forecast regression analysis table, and stores the second failure forecast value into the program job damage degree table in the evaluation result DB 41 (step S83). The second failure forecast value is a value calculated by adding all of (the partial regression coefficient of the property i*the property value of the property i) for each of the properties 1 to m (m is the maximum value of the property number. However, this is limited to only the properties to be analyzed). The program job damage degree table becomes a state as depicted in FIG. 30, for example.

In the example of FIG. 30, the table includes a column of a program name (or ID), a column of a job damage rank, a column of a damage degree per one failure, a column of a first failure forecast value, a column of a second failure value, a column of a cost influence ratio, a column of the number of latent failures, a column of a damage risk, a column of an ideal cost and a column of a quality keeping cost. However, a column to which data is registered at the step S83 is limited to the column of the second failure forecast value. Thus, the second failure forecast value that the cost effectiveness is excluded, is calculated.

After that, the quality maintenance cost judgment unit 402 calculates, for each program, a cost influence ratio by calculating the first failure forecast value/the second failure by using the data stored in the program job damage degrees table, and stores the cost influence ratio into the program job damage degree table (step S85). In the program job damage degree table depicted in FIG. 30, data is registered into the column of the cost influence ratio. Thus, by the cost influence ratio, which is a ratio of the first failure forecast value, which is calculated by taking into consideration the cost effectiveness to the second failure forecast value, is calculated by excluding the cost effectiveness, the cost effectiveness is judged. Namely, it is calculated how mach the failure forecast value decreases when the cost is added as one property.

Then, the quality keeping cost judgment unit 402 analyzes the correlation between the cost per the functional scale (property 7) for each program, which is stored in the resource property table in the analysis data DB 37, and the cost influence ratio for each program, which is stored in the program job damage degree table, by the partial regression analysis, and stores data of the calculated partial regression coefficient and the cut (y-cut) as a cost influence ratio data table, into the evaluation result DB 41 (step S87). For example, the cost influence ratio data table as depicted in FIG. 32 is generated and stored.

FIG. 31 represents a regression line B. which is identified by the partial regression coefficient and cut, calculated at the step S87, and a sequence of points identified by the cost per the functional scale and the cost influence ratio. In the graph of FIG. 31, the vertical axis represents the cost influence ratio and the horizontal axis represents the cost per the functional scale. From this regression line B. it is understood how may failures can be decreased in case of how much cost would be spent, and it can be calculated how much cost per one functional scale should be spent in order to prevent any failure from occurring, namely, make the cost influence ratio=0%. Incidentally, in the example of FIG. 31, it can be understood that there is possibility that the number of failures becomes “0” when spending about 17.3 as the cost per one functional scale.

Next, the quality ensuring cost determination processing (step S55) will be explained by using FIG. 33. The quality keeping cost judgment unit 402 calculates the cost (x-cut) per the functional scale in a case where the cost influence ratio becomes “0” from the data (y-cut and partial regression coefficient) in the cost influence ratio data table, and stores the value of the x-cut into the cost influence ratio data table (step S91). This processing itself is well-known, and the further explanation is omitted.

The quality keeping cost judgment unit 402 calculates an ideal cost from a product of the functional scale (property 6) for each program, which is stored in the resource property table in the analysis data DB 37, and the cost (x-cut) per the functional scale in case where the cost influence ratio becomes “0”, wherein the x-cut is stored in the cost influence ratio data table, and stores the ideal cost into the program job damage degree table (step S93). In the resource property table depicted in FIG. 8, the property value of the property 6 for PGM 1 is “10”. Therefore, from the value “17.3” of the x-cut, the ideal cost becomes about “173” (=17.3*10). This value is registered in the column of the ideal cost in the program job damage degree table depicted in FIG. 30. Incidentally, the programs for which the ideal cost should be calculated may be all of the programs, or may be limited to the programs for which ON is set to the target flag.

Then, the quality keeping cost judgment unit 402 calculates, for each program, a quality ensuring cost by computing the ideal cost*(1−the accumulated number of failures/the first failure forecast value), and stores the quality ensuring cost into the program job damage degree table (step S95). (1−the accumulated number of failures/the first failure forecast value) can be substituted by (the number of latent failures/the first failure forecast value). Incidentally, the programs for which the quality ensuring cost should be calculated may be all programs, or may be limited to the programs for which ON is set to the target flag.

As depicted in the column of the quality ensuring cost in FIG. 30, the quality ensuring cost can be calculated as a cost to suppress occurrence of the latent failure.

By carrying out the aforementioned processing, it becomes possible to carry out the maintenance for the program having high cost-effectiveness, and to estimate the cost for the maintenance fee based on the present maintenance state. In addition, based on the aforementioned various indexes, it is possible to assign the priority to the program for which the maintenance should be carried out.

Although one embodiment of this invention was explained above, this invention is not limited to this embodiment. For example, the functional blocks of the program analysis apparatus 3 depicted in FIG. 2 do not always correspond to an actual program module configuration. In addition, as described above, the functions of the program analysis apparatus 3 depicted in FIG. 2 may be realized in the user terminal, for example. In addition, in FIG. 1, it is possible to connect the program analysis apparatus 3 with a network such as the Internet to provide the service by the apparatus to the outside users.

Furthermore, as for the processing flow, as long as the processing result is the same, the order can be changed or the steps may be executed in parallel.

Incidentally, the program analysis apparatus 3 and user terminal are computer devices as shown in FIG. 34. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 34. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the computer-readable removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

What is claimed is:

1. A computer-implemented program analysis method, comprising:
analyzing, for each program, correlation between a plurality of property values of properties including a property concerning a cost, and an accumulated number of failures, wherein said plurality of property values are stored in a property data storage device, and said accumulated number of failures is stored in a quality result data storage device;
calculating a failure forecast value for each said program, based on an analysis result and said plurality of property values of said properties including said property concerning said cost;
calculating a latent risk value for each said program, based on said accumulated number of failures, said failure forecast value and an assumed damage degree per one failure; and
selecting a program to be processed, based on said latent risk values.

2. The computer-implement program analysis method as set forth in claim 1, further comprising:
analyzing, for each said program, correlation between a plurality of property values of properties exclusive of said property concerning said cost and said accumulated number of failures, to obtain a second analysis result;
calculating a second failure forecast value for each said program, based on said second analysis result and said plurality of property values of said properties exclusive of said property concerning said cost;
calculating, for each said program, a cost influence ratio based on said first failure forecast value and said second failure forecast value;
calculating a unit cost that represents a cost per a functional scale, which is necessary to make a number of failures zero, based on said cost influence ratio for each said program and a property value concerning said cost per said functional scale of each said program; and
calculating a cost necessary to ensure a predetermined level of quality for at least the identified program to be processed, by using said unit cost, said property value concerning said cost per said functional scale of each said program, said failure forecast value for each said program and said accumulated number of failures or a number of latent failures, which is a difference between said failure forecast value and said accumulated number of failures.

3. The computer-implemented program analysis method as set forth in claim 1, further comprising:
calculating said assumed damage degree per one damage, based on a damage cost corresponding to a job damage rank of a program and a cost of said program, which corresponds to a specific property included in said plurality of properties.

4. The computer-implemented program analysis method as set forth in claim 1, wherein said calculating said latent risk value comprises:
calculating, for each said program, a number of latent failures based on said accumulated number of failures and said failure forecast value; and
calculating, for each said program, said latent risk value based on said number of latent failures and said assumed damage degree per one failure.

5. The computer-implemented program analysis method as set forth in claim 1, wherein said selecting comprises:
sorting said programs based on said latent risk values; and
accumulating said latent risk values in an ascending order of said latent risk values, and selecting, as said programs to be processed, a specific program at which the accumulated latent risk value exceeds a predetermined threshold and programs whose latent risk value is greater than said latent risk value of said specific program.

6. The computer-implemented program analysis method as set forth in claim 2, wherein said calculating said unit cost comprises:
analyzing correlation between said cost influence ratio for each said program and said property value concerning said cost per said functional scale for each said program, to obtain a third analysis result; and
calculating, as said unit cost, a cost per said functional scale at which said cost influence ratio becomes zero, according to said third analysis result.

7. The computer-implemented program analysis method as set forth in claim 2, wherein said calculating said cost comprises:
calculating, for each said program, an ideal cost, based on said unit cost and said property value concerning said cost per said functional scale for each said program;
calculating a failure rate for said failure forecast value for at least said program to be processed, by using said failure forecast value for each said program and said accumulated number of failures or said number of latent failures, which represents said difference between said failure forecast value and said accumulated number of failures; and
calculating said cost necessary to ensure said predetermined level of quality for at least said program to be processed, based on said ideal cost for each said program and said failure rate for said failure forecast value.

8. A computer-implemented program analysis method, comprising:
analyzing, for each program, correlation between a plurality of property values of properties including a property concerning a cost and an accumulated number of failures, wherein said plurality of property values are stored in a property data storage device, and said accumulated number of failures is stored in a quality result data storage device;
calculating, for each said program, a first failure forecast value, based on the analysis result and said plurality of property values of said properties including said property concerning said cost;
analyzing, for each said program, correlation between a plurality of property values of properties exclusive of said property concerning said cost and said accumulated number of failures to obtain a second analysis result;
calculating, for each said program, a second failure forecast value, based on said second analysis result and said plurality of property values of said properties exclusive of said property concerning said cost;
calculating, for each said program, a cost influence ratio based on said first failure forecast value and said second failure forecast value;
calculating a unit cost, which represents a cost per a functional scale, which is necessary to make the failure zero, based on said cost influence ratio for each said program and a property value concerning said cost per said functional scale for each said program; and
calculating a cost necessary to ensure a predetermined level of quality for at least a part of programs, by using said unit cost, said property value concerning said cost per said functional scale for each said program, said first failure forecast value for each said program and said accumulated number of failures or a number of latent failures, which is a difference between said first failure forecast value and said accumulated number of failures.

9. A computer readable storage medium storing a program for causing a computer to execute a program analysis process comprising:
analyzing, for each program, correlation between a plurality of property values of properties including a property concerning a cost, and an accumulated number of failures, wherein said plurality of property values are stored in a property data storage device, and said accumulated number of failures is stored in a quality result data storage device;
calculating a failure forecast value for each said program, based on an analysis result and said plurality of property values of said properties including said property concerning said cost;
calculating a latent risk value for each said program, based on said accumulated number of failures, said failure forecast value and an assumed damage degree per one failure; and
selecting a program to be processed, based on said latent risk values.

10. A computer readable storage medium storing a program for causing a computer to execute a program analysis process comprising:
analyzing, for each program, correlation between a plurality of property values of properties including a property concerning a cost and an accumulated number of failures, wherein said plurality of property values are stored in a property data storage device, and said accumulated number of failures is stored in a quality result data storage device;
calculating, for each said program, a first failure forecast value, based on the analysis result and said plurality of property values of said properties including said property concerning said cost;
analyzing, for each said program, correlation between a plurality of property values of properties exclusive of said property concerning said cost and said accumulated number of failures to obtain a second analysis result;
calculating, for each said program, a second failure forecast value, based on said second analysis result and said plurality of property values of said properties exclusive of said property concerning said cost;
calculating, for each said program, a cost influence ratio based on said first failure forecast value and said second failure forecast value;
calculating a unit cost, which represents a cost per a functional scale, which is necessary to make the failure zero, based on said cost influence ratio for each said program and a property value concerning said cost per said functional scale for each said program; and
calculating a cost necessary to ensure a predetermined level of quality for at least a part of programs, by using said unit cost, said property value concerning said cost per said functional scale for each said program, said first failure forecast value for each said program and said accumulated number of failures or a number of latent failures, which is a difference between said first failure forecast value and said accumulated number of failures.

11. A program analysis apparatus, comprising:
a property data storage device storing a plurality of property values of properties;
a quality result data storage device storing an accumulated number of failures;
a unit that analyzes, for each said program, correlation between a plurality of property values of properties including a property concerning a cost and said accumulated number of failures;
a unit that calculates a failure forecast value for each said program, based on an analysis result and said plurality of property values of said properties including said property concerning said cost;
a unit that calculates a latent risk value for each said program, based on said accumulated number of failures, said failure forecast value and an assumed damage degree per one failure; and
a unit that selects a program to be processed, based on said latent risk values.

12. A program analysis apparatus, comprising:
a property data storage device storing a plurality of property values of properties;
a quality result data storage device storing an accumulated number of failures;
a unit that analyzes, for each said program, correlation between a plurality of property values of properties including a property concerning a cost and an accumulated number of failures;
a unit that calculates, for each said program, a first failure forecast value, based on the analysis result and said plurality of property values of said properties including said property concerning said cost;
a unit that analyzes, for each said program, correlation between a plurality of property values of properties exclusive of said property concerning said cost and said accumulated number of failures to obtain a second analysis result;
a unit that calculates, for each said program, a second failure forecast value, based on said second analysis result and said plurality of property values of said properties exclusive of said property concerning said cost;
a unit that calculates, for each said program, a cost influence ratio based on said first failure forecast value and said second failure forecast value;
a unit that calculates a unit cost, which represents a cost per a functional scale, which is necessary to make the failure zero, based on said cost influence ratio for each said program and a property value concerning said cost per said functional scale for each said program; and
a unit that calculates a cost necessary to ensure a predetermined level of quality for at least apart of programs, by using said unit cost, said property value concerning said cost per said functional scale for each said program, said first failure forecast value for each said program and said accumulated number of failures or a number of latent failures, which is a difference between said first failure forecast value and said accumulated number of failures.
